(19) United States
(12) Patent Application Publication
(10) Pub. No.: US 2025/0218290 A1
(43) Pub. Date: Jul. 3, 2025

(54) Method For The Infrastructure-based Assistance of a Motor Vehicle

(71) Applicant: Robert Bosch GmbH, Stuttgart-Feuerbach (DE)

(72) Inventors: Stefan Nordbruch, Leonberg (DE); Adwait Sanjay Kale, Ludwigsburg (DE); Leonard Hoffmann, Wien (AT); Jacqueline Erhart, Wien (AT); Gottfried Allmer, Brand-Laaben (AT)

(73) Assignee: Robert Bosch GmbH, Stuttgart-Feuerbach (DE)

(21) Appl. No.: 19/080,125

(22) Filed: Mar. 14, 2025

Related U.S. Application Data
(63) Continuation of application No. PCT/EP2023/075519, filed on Sep. 15, 2023.

(30) Foreign Application Priority Data
Sep. 15, 2022 (DE) 10 2022 123 608.0

(51) Int. Cl. G08G 1/0967; G08G 1/01

(52) U.S. Cl. CPC G08G 1/096708; G08G 1/0116; G08G 1/0133; G08G 1/0141; G08G 1/096741; G08G 1/096783

(57) ABSTRACT

A method for an infrastructure-based assistance of a motor vehicle during a journey through an infrastructure includes determining whether the motor vehicle requires the infrastructure-based assistance for the journey through the infrastructure. When the motor vehicle requires the infrastructure-based assistance for the journey through the infrastructure, the method includes the following steps: determining an infrastructure assistance data for the journey of the motor vehicle through the infrastructure, generating a periodic message including the infrastructure assistance data, and transmitting the periodic message including the infrastructure assistance data to the motor vehicle. When the motor vehicle does not require infrastructure-based assistance for the journey through the infrastructure, the method includes the following steps: generating a periodic message without an infrastructure assistance data, and transmitting the periodic message without the infrastructure assistance data to the motor vehicle.

### CROSS-REFERENCE TO RELATED APPLICATIONS

This application is a continuation of PCT International Application No. PCT/EP2023/075519, filed on Sep. 15, 2023, which claims priority under 35 U.S.C. § 119 to German Patent Application DE 10 2022 123 608.0, filed on Sep. 15, 2022.

### FIELD OF THE INVENTION

The invention relates to a method and to a system for the infrastructure-based assistance of a motor vehicle during a journey through an infrastructure.

### BACKGROUND

The published patent application DE 10 2015 219 785 Al discloses a method for configuring a data transmission via a transmission channel of a wireless communication system.

The published patent application KR 10 2016 048 020 A discloses a method for a vehicle-to-vehicle communication.

The patent U.S. Pat. No. 6,604,036 B1 discloses a method for establishing a remote data connection to a vehicle.

The patent U.S. Pat. No. 9,429,985 B2 discloses a method for reducing a computing capacity within the framework of a vehicle communication.

The published patent application US 2020/0367104 A1 discloses a method for controlling a user equipment in a first network with a resource control server.

The published patent application WO 2015/025056 A1 discloses a filtering of infrastructure description messages.

### SUMMARY

A method for an infrastructure-based assistance of a motor vehicle during a journey through an infrastructure includes determining whether the motor vehicle requires the infrastructure-based assistance for the journey through the infrastructure. When the motor vehicle requires the infrastructure-based assistance for the journey through the infrastructure, the method includes the following steps: determining an infrastructure assistance data for the journey of the motor vehicle through the infrastructure, generating a periodic message including the infrastructure assistance data, and transmitting the periodic message including the infrastructure assistance data to the motor vehicle. When the motor vehicle does not require infrastructure-based assistance for the journey through the infrastructure, the method includes the following steps: generating a periodic message without an infrastructure assistance data, and transmitting the periodic message without the infrastructure assistance data to the motor vehicle.

### BRIEF DESCRIPTION OF THE DRAWINGS

The invention will now be explained with reference to embodiments. In the drawings:

FIG. 1 shows a flow chart of a method according to a first aspect;

FIG. 2 shows an apparatus according to a second aspect;

FIG. 3 shows a system according to a third aspect;

FIG. 4 shows a machine-readable storage medium according to a fifth aspect;

FIG. 5 is a schematic diagram of an infrastructure in a first state; and

FIG. 6 is a schematic diagram of the infrastructure in a second state.

### DETAILED DESCRIPTION OF THE EMBODIMENT(S)

The invention is based on the efficient infrastructure-based assistance of a motor vehicle during a journey through an infrastructure.

According to a first aspect, a method for the infrastructure-based assistance of a motor vehicle during a journey through an infrastructure is provided, which method includes the following steps: determining whether the motor vehicle requires infrastructure-based assistance for its journey through the infrastructure.

When the motor vehicle requires infrastructure-based assistance for its journey through the infrastructure, the method includes the following steps: determining infrastructure assistance data for the journey of the motor vehicle through the infrastructure, generating a periodic message including the determined infrastructure assistance data, and transmitting the periodic message including the determined infrastructure assistance data to the motor vehicle.

When the motor vehicle does not require infrastructure-based assistance for its journey through the infrastructure, the method includes the following steps: generating a periodic message without infrastructure assistance data, and transmitting the periodic message without infrastructure assistance data to the motor vehicle.

According to a second aspect, an apparatus is provided, which is designed to carry out all steps of the method according to the first aspect.

According to a third aspect, a system for the infrastructure-based assistance of a motor vehicle during a journey through an infrastructure is provided, including: at least one surroundings sensor arranged within the infrastructure, which is designed to detect a surroundings of the motor vehicle and to output surroundings signals which are based on the detection and represent the surroundings of the motor vehicle, and the apparatus according to the second aspect.

According to a fourth aspect, a computer program is provided, which includes commands which, when the computer program is run by a computer, for example, by the apparatus according to the second aspect and/or by the system according to the third aspect, prompt these to carry out a method according to the first aspect.

According to a fifth aspect, a machine-readable storage medium is provided, on which the computer program according to the fourth aspect is stored.

The invention is based on the knowledge—and incorporates this knowledge—that the aforementioned object is achieved by transmitting a periodic message to the motor vehicle at predetermined, in particular regular, time intervals. A transmitted periodic message includes either infrastructure assistance data, on the basis of which the motor vehicle can travel through the infrastructure. Or the periodic message does not include infrastructure assistance data, i.e., has no infrastructure assistance data or is free of infrastructure assistance data.

This means that, prior to any transmission of a periodic message, it is initially determined whether there is actually a requirement or a need for assistance by the infrastructure for the journey of the motor vehicle through the infrastructure.

Therefore, it is determined by the infrastructure whether the motor vehicle requires infrastructure-based assistance for its journey through the infrastructure or not. The decision as to whether it is necessary that the motor vehicle be supported or must be supported by the infrastructure, or whether the motor vehicle is to be assisted or must be assisted by the infrastructure is therefore reached, in particular, by the infrastructure.

If the decision is positive, infrastructure assistance data are determined. In this case, the periodic message includes these determined infrastructure assistance data. When the decision is negative, i.e., when there is no need for infrastructure assistance, a periodic message is nevertheless transmitted to the motor vehicle, with the exception that, in this case, the periodic message does not include infrastructure assistance data.

This means that periodic messages are always transmitted to the motor vehicle. Depending on a need for infrastructure assistance, these periodic messages either include infrastructure assistance data or do not include infrastructure assistance data. Therefore, in particular, a regular transmission of periodic messages from the infrastructure to the motor vehicle takes place, wherein the periodic messages include infrastructure assistance data or not depending on whether there is a need for the infrastructure assistance.

This means, in particular, that periodic messages are transmitted from the infrastructure regardless of whether, for example, a request from a motor vehicle for infrastructure assistance has been received by the infrastructure or whether, for example, a request from a motor vehicle for a remote control by the infrastructure has been received by the infrastructure.

Therefore, it is advantageously made possible to transmit fewer data to the motor vehicle in the cases in which there is no need for infrastructure assistance and, in this case, to transmit only the periodic message without infrastructure assistance data, as compared to the case in which the periodic message always includes infrastructure assistance data regardless of whether there is actually a need for infrastructure assistance. Therefore, advantageously, an existing bandwidth can be efficiently utilized.

The use of periodic messages, which are transmitted to the motor vehicle at predetermined time intervals, in particular at predetermined regular time intervals, yields in particular the technical advantage that the motor vehicle can be efficiently informed that communication with the infrastructure still functions. This is the case because the concept of periodic messages is based in particular on the fact that such messages are transmitted to the motor vehicle at intervals that can be expected by the motor vehicle, in order, in particular, to signal to the motor vehicle that communication is still possible, that the infrastructure still functions, i.e., for all intents and purposes is still alive. When the motor vehicle does not receive an expected periodic message at the predetermined point in time, this can be a sign to the motor vehicle, for example, that an error has occurred in the communication with the infrastructure and/or, for example, that an error has occurred in the infrastructure, which can result, for example, in the infrastructure no longer being able to provide infrastructure assistance at the moment. This information can be efficiently used by the motor vehicle for planning its own journey. For example, during a journey of the motor vehicle carried out in an at least semi-automated manner, the motor vehicle can request that the driver take over the guidance of the motor vehicle again in such a case, since infrastructure assistance required for the journey carried out in an at least semi-automated manner is not available at the moment. For example, the motor vehicle can reduce its speed and/or, for example, increase a distance to road users in its surroundings and/or, for example, carry out a safe emergency stop.

This yields in particular the technical advantage that the motor vehicle can be efficiently supported during a journey through an infrastructure, or that the motor vehicle can be efficiently assisted during a journey through the infrastructure.

After all, this therefore yields the technical advantage that a concept for the efficient infrastructure-based assistance of a motor vehicle during a journey through an infrastructure is provided. Throughout the specification, the terms “assist” and “support” can be used synonymously.

A journey by the motor vehicle through an infrastructure is, for example, a journey carried out in an at least semi-automated manner, i.e., a journey during which the motor vehicle is guided in an at least semi-automated manner. The wording “at least semi-automated guidance” includes one or more of the following cases: assisted guidance, semi-automated guidance, highly automated guidance, fully automated guidance. The wording “at least semi-automated” therefore includes one or more of the following wordings: assisted, semi-automated, highly automated, fully automated.

Assisted guidance means that a driver of the motor vehicle continuously carries out either the transverse guidance or the longitudinal guidance of the motor vehicle. The respective other driving task (i.e., controlling the longitudinal guidance or the transverse guidance of the motor vehicle) is automatically carried out. This means, therefore, that either the transverse guidance or the longitudinal guidance is automatically controlled during an assisted guidance of the motor vehicle.

Semi-automated guidance means that a longitudinal guidance and a transverse guidance of the motor vehicle are automatically controlled in a specific situation (for example: traveling on an expressway, traveling within a parking facility, passing an object, traveling within a lane defined by lane markings) and/or for a certain period of time. A driver of the motor vehicle does not need to manually control the longitudinal guidance and the transverse guidance of the motor vehicle him/herself. However, the driver must continuously monitor the automatic control of the longitudinal guidance and the transverse guidance in order to be able to manually intervene as necessary. The driver must always be prepared to completely take over the guidance of the motor vehicle.

Highly automated guidance means that a longitudinal guidance and a transverse guidance of the motor vehicle are automatically controlled for a certain period of time in a specific situation (for example: traveling on an expressway, traveling within a parking facility, passing an object, traveling within a lane defined by lane markings). A driver of the motor vehicle does not need to manually control the longitudinal guidance and the transverse guidance of the motor vehicle him/herself. The driver does not need to continuously monitor the automatic control of the longitudinal guidance and the transverse guidance in order to be able to manually intervene as necessary. As necessary, a take-over request is automatically output to the driver to take over the control of the longitudinal guidance and the transverse guidance, which take-over request is output in particular with a sufficient time buffer. The driver must therefore potentially be able to take over the control of the longitudinal guidance and the transverse guidance. Limits of the automatic control of the transverse guidance and the lateral guidance are automatically detected. During highly automated guidance, it is not possible in every initial situation to automatically bring about a minimal-risk state.

Fully automated guidance means that a longitudinal guidance and a transverse guidance of the motor vehicle are automatically controlled in a specific situation (for example: traveling on an expressway, traveling within a parking facility, passing an object, traveling within a lane defined by lane markings). A driver of the motor vehicle does not need to manually control the longitudinal guidance and the transverse guidance of the motor vehicle him/herself. The driver does not need to monitor the automatic control of the longitudinal guidance and the transverse guidance in order to be able to manually intervene as necessary. Prior to a termination of the automatic control of the transverse guidance and the longitudinal guidance, a request is automatically transmitted to the driver to take over the driving task (control of the transverse guidance and the longitudinal guidance of the motor vehicle), in particular with a sufficient time buffer. If the driver does not take over the driving task, there is an automatic return to a minimal-risk state. Limits of the automatic control of the transverse guidance and the lateral guidance are automatically detected. In all situations, it is possible to automatically return to a minimal-risk system state.

When the singular is used for the motor vehicle within the framework of the description, the plural is always to be assumed, and vice versa. This means, for example, that multiple motor vehicles can be supported in an infrastructure-based manner during a journey through an infrastructure. For example, in such a case, it is determined separately for each of the motor vehicles whether the particular motor vehicle requires infrastructure-based assistance for its journey through the infrastructure. This means in particular that, in such a case, depending on the result of this determination, for example either a periodic message including infrastructure assistance data is transmitted to the particular motor vehicle or a periodic message that does not include infrastructure assistance data is transmitted to the motor vehicle.

Therefore, in the example in which multiple motor vehicles are supported by the infrastructure during a journey through an infrastructure, an existing communication infrastructure with the motor vehicles can be efficiently utilized. This means, for example, that an existing transmission capacity or, in general, communication capacity, can be efficiently utilized. An available bandwidth can therefore be efficiently utilized.

This can be seen, in particular, relative to the case in which infrastructure assistance data are always determined for all motor vehicles located within the infrastructure regardless of a need and these determined infrastructure assistance data are always transmitted to the motor vehicles. In this case, more data in total are transmitted to the motor vehicles as compared to the concept described here. This applies similarly for a processing capacity with regard to the steps of determining, which processing capacity is present in the infrastructure and can also be efficiently used according to the concept described here. This can be seen, in particular, relative to the case described here, according to which infrastructure assistance data are always determined regardless of a need for the motor vehicles.

An infrastructure includes, for example, one of the following infrastructure elements: a nodal point, for example, an intersection, a junction, a roundabout, an expressway on-ramp, an expressway off-ramp, an expressway, a highway, a highway on-ramp, a highway off-ramp, a tunnel, a tunnel entrance, a tunnel exit, a construction site, a construction site entrance, a construction site exit, a parking facility, in particular a parking deck, a parking garage, a road, a one-way street, a bridge.

A transmission within the framework of the description includes, for example, a transmission via a wireless communication network. A wireless communication network includes, for example, a WLAN network and/or a mobile communication network.

In one embodiment, the method includes the following steps: receiving surroundings signals, which represent a surroundings of the motor vehicle. This yields, for example, the technical advantage that knowledge of the surroundings of the motor vehicle can be efficiently obtained, wherein this knowledge can be advantageously used, in particular as the basis for one or more further method steps.

In one embodiment of the method, the infrastructure assistance data are determined on the basis of the surroundings signals. This yields, for example, the technical advantage that this determination can be efficiently carried out.

In one embodiment, the method includes the following steps: receiving surroundings signals, which represent a surroundings of the motor vehicle, wherein the infrastructure assistance data are determined on the basis of the surroundings signals. This yields, for example, the technical advantage that this determination can be efficiently carried out.

In one embodiment of the method, it is determined on the basis of the surroundings signals whether the motor vehicle requires infrastructure-based assistance for its journey through the infrastructure. This yields, for example, the technical advantage that this determination can be efficiently carried out.

In one embodiment of the method, the method includes the following steps:
determining a list of objects, which indicates objects located in the surroundings of the motor vehicle, on the basis of the surroundings signals,
determining a particular relevance of the objects in the list of objects with regard to a relevance for the journey of the motor vehicle through the infrastructure,
wherein, on the basis of the determined relevances, it is determined whether the motor vehicle requires infrastructure-based assistance for its journey through the infrastructure, wherein, when the motor vehicle requires infrastructure-based assistance for its journey through the infrastructure, determining the infrastructure assistance data includes selecting a sub-plurality of objects from the list of objects on the basis of the determined relevances in order to determine a reduced list of objects, which indicates the selected objects, such that the infrastructure assistance data include the reduced list of objects.

This yields, for example, the technical advantage that an existing transmission capacity can be efficiently utilized, since, depending on the determined relevances, it is not the entire list of objects that is transmitted to the motor vehicle, but rather only a reduced list of objects. Therefore, depending on the relevances, fewer data can be transmitted to the motor vehicle.

According to this embodiment, an object detection is therefore carried out on the basis of the surroundings signals in order to detect objects in the surroundings of the motor vehicle. The detected objects are entered in a list of objects. The list of objects provides, for example, the following information about the detected objects: position, speed, direction of travel, acceleration, deceleration; object type, for example, motor vehicle, motorcycle, two-wheeled vehicle, pedestrian, bicycle, animal; dimension, in particular length, height, width.

Transmitting a list of objects or a reduced list of objects yields the technical advantage that the motor vehicle efficiently obtains knowledge of its surroundings, which would possibly not be available merely on the basis of its own motor vehicle surroundings sensors. This is the case because surroundings sensors of the infrastructure can, for example, detect objects in the surroundings of the motor vehicle that cannot be detected by the surroundings sensors of the motor vehicle, for example because such objects can be concealed by other objects in the surroundings of the motor vehicle.

In one embodiment of the method, the method includes the following steps: carrying out a free space detection on the basis of the surroundings signals in order to determine a free-space-detection result, which indicates a particular occupancy status—which is relevant to the journey of the motor vehicle through the infrastructure—of at least one surface in the surroundings of the motor vehicle, wherein the occupancy status indicates one of the following states: free, occupied, or unknown, wherein, on the basis of the particular occupancy status, it is determined whether the motor vehicle requires infrastructure-based assistance for its journey through the infrastructure, wherein, when the motor vehicle requires infrastructure-based assistance for its journey through the infrastructure, determining the infrastructure assistance data includes selecting those areas that are either free or occupied and/or have an unknown occupancy status in order to determine a reduced free-space-detection result, which indicates only free surfaces or occupied surfaces and/or surfaces having an unknown occupancy status, such that the infrastructure assistance data include the reduced free-space-detection result.

This yields, for example, the technical advantage that, similarly to the above-described embodiment relating to the list of objects, an existing transmission capacity or an existing bandwidth can also be efficiently utilized. Similarly, in an efficient way, fewer data can be transmitted, provided the reduced free-space-detection result is transmitted to the motor vehicle. The comments presented above with regard to the advantages apply, in particular similarly.

According to this embodiment, a free space detection is therefore carried out on the basis of the surroundings signals. Within the framework of a free space detection, in particular, the at least one surface is compared with a correspondingly associated reference surface, wherein an occupancy state of the reference surface is known. It is therefore recognized whether there is a difference with regard to the occupancy state or the occupancy status, wherein these two terms can be used synonymously.

Within the framework of a free space detection, a known reference world is used as a starting point, which reference world is compared with the surroundings signals in order to detect differences. Differences can therefore mean that the particular occupancy state of the at least one surface has changed. Within the framework of a free space detection, it is therefore not necessary to know what type of object is located on the surface, but rather information is merely transmitted that indicates that the surface is occupied or unoccupied. Within the framework of the free space detection, it is also possible that the occupancy state cannot be unambiguously established. In this case, the occupancy state is indicated as unknown.

In one embodiment of the method, the surroundings signals include one or more elements selected from the following group of signals: weather signals, which represent weather in the surroundings of the motor vehicle; road state data, which represent a road state of one or more roads in the surroundings of the motor vehicle; traffic state signals, which represent a traffic state in the surroundings of the motor vehicle; map signals, which represent a digital map of the surroundings of the motor vehicle; traffic sign signals, which represent what the traffic sign is displaying at the moment and/or will display in the future; signals from traffic light systems, which represent a current and/or future signal image of the traffic light system; remaining-time signals, which represent a remaining time of a light signal, in particular of a red light or a green light, of a traffic light system; surroundings model of the surroundings; object data describing at least one object in the surroundings; occupancy status data describing an occupancy status of at least one surface in the surroundings; particular surroundings sensor data, in particular surroundings sensor raw data, based on a detection of the surroundings using at least one surroundings sensor; surroundings sensor data-fusion data, in particular surroundings sensor raw data-fusion data, based on multiple detections of the surroundings using multiple surroundings sensors.

This yields, for example, the technical advantage that particularly suitable information regarding the surroundings of the motor vehicle is available and therefore can be used, for example, for determining the infrastructure assistance data and/or, for example, for determining whether infrastructure assistance is required.

Surroundings sensor data describe, in particular, the surroundings of the motor vehicle as viewed from the particular surroundings sensor. Surroundings sensor data include, for example, surroundings sensor raw data and/or processed surroundings sensor raw data, which can be referred to, in particular, as preprocessed surroundings sensor data. Surroundings sensor data-fusion data are fused surroundings sensor data. Surroundings sensor raw data-fusion data are fused surroundings sensor raw data.

In one embodiment of the method, an information content of information represented by the surroundings signals is reduced, such that the infrastructure assistance data include the reduced information content. This yields, for example, the technical advantage that fewer data as compared with the non-reduced information content can be transmitted to the motor vehicle, such that, for example, an existing bandwidth can be efficiently utilized.

An occupancy status of a surface indicates, in particular, one of the following states: free, occupied, or unknown.

In one embodiment of the method, when the motor vehicle requires infrastructure-based assistance for its journey through the infrastructure, meta-information regarding that which is not included in the infrastructure assistance data due to “the reduced” is determined, such that the infrastructure assistance data include the determined meta-information. This yields, for example, the technical advantage that the motor vehicle is efficiently made capable of knowing what information it is that the motor vehicle has not received. Therefore, the motor vehicle knows—and can take this knowledge into account in its own trip planning—that transmission errors did not lead, for example, to a complete list of objects or, for example, a complete free-space-detection result, not having been transmitted to the motor vehicle, in general the entire information content, but rather only a reduced version thereof, i.e., in general the reduced information content, having been transmitted to the motor vehicle.

In one embodiment of the method, the infrastructure assistance data are determined depending on a transmission capacity, which indicates a capacity with regard to the transmission of infrastructure assistance data to the motor vehicle, and/or on a processing capacity, which indicates a capacity with regard to a determination of infrastructure assistance data. This yields, for example, the technical advantage that the infrastructure assistance data can be efficiently determined.

A processing capacity indicates, for example, how much processing power is available for the steps of determining. A transmission capacity indicates, for example, how much bandwidth is available for transmitting the periodic message.

In one embodiment of the method, the steps with regard to determining the reducing are carried out on the basis of the transmission capacity and/or on the basis of the processing capacity, such that, depending on the transmission capacity and/or depending on the processing capacity, either “the non-reduced” or “the reduced” is included in the infrastructure assistance data. This yields, for example, the technical advantage that an existing transmission capacity and/or an existing processing capacity can be efficiently utilized. If, for example, the transmission capacity and/or the processing capacity are/is not sufficient for transmitting the entire list of objects and/or the entire free-space-detection result and/or the entire information content to the motor vehicle, then, for example, the reduced list of objects and/or the reduced free-space-detection result and/or the reduced information content, respectively, are/is determined and transmitted to the motor vehicle.

For example, when the processing capacity is lower than or lower than or equal to a predetermined processing capacity threshold value, a reduced list of objects and/or a reduced free-space-detection result and/or the reduced information content can be determined and correspondingly transmitted to the motor vehicle.

For example, when the transmission capacity is lower than or lower than or equal to a predetermined transmission capacity threshold value, the reduced list of objects and/or the reduced free-space-detection result and/or the reduced information content can be determined and correspondingly transmitted to the motor vehicle.

In one embodiment of the method, the steps with regard to the reducing are carried out on the basis of an established rhythm, such that, on the basis of the established rhythm, either “the non-reduced” or “the reduced” are included in the infrastructure assistance data. This yields, for example, the technical advantage that the infrastructure assistance data can be efficiently determined. In particular, this yields the technical advantage that an existing transmission capacity and/or an existing processing capacity can be efficiently utilized.

According to this embodiment, therefore, either the reduced object list and/or the reduced free-space-detection result and/or the reduced information content or even “the non-reduced” are/is transmitted to the motor vehicle in an established rhythm. The established rhythm depends, in particular, on a transmission frequency of the periodic messages. For example, the reduced list of objects and/or the reduced free-space-detection result and/or the reduced information content are/is transmitted to the motor vehicle each nth time, wherein, at the other times, the entire free-space-detection result and/or the entire list of objects and/or the entire information content are/is always transmitted to the motor vehicle. n is a natural number and is greater than 1. This therefore yields, for example, the technical advantage that the motor vehicle always receives an entire list of objects and/or always receives an entire free-space-detection result and/or always receives an entire information content at regular intervals.

Therefore, the motor vehicle always obtains a complete overview of its surroundings at certain intervals in an efficient way. The motor vehicle can therefore plan its journey through the infrastructure in an efficient way.

The wording “the reduced” includes, in particular, the following: reduced list of objects and/or reduced free-space-detection result and/or reduced information content.

The wording “the non-reduced” includes, in particular, the following: entire list of objects and/or entire free-space-detection result and/or entire information content.

In one embodiment of the method, trajectory signals are received and/or determined, which trajectory signals represent a particular target trajectory of the motor vehicle and/or of at least one road user in the surroundings of the motor vehicle, wherein, on the basis of the trajectory signals, it is determined whether the motor vehicle requires infrastructure-based assistance for its journey through the infrastructure, and/or wherein the infrastructure assistance data are determined on the basis of the trajectory signals. This yields, for example, the technical advantage that the infrastructure assistance data can be efficiently determined. In particular, this yields the technical advantage that it can be efficiently determined whether the motor vehicle requires infrastructure-based assistance for its journey through the infrastructure.

When, for example, the target trajectory specifies that the motor vehicle is not planning to change lanes, it can be established, for example, that the motor vehicle does not require infrastructure assistance. Otherwise, it can be established, for example, that the motor vehicle requires infrastructure assistance.

When, for example, the target trajectory of the at least one road user in the surroundings of the motor vehicle specifies that the at least one road user plans to change lanes, it can be established, for example, that the motor vehicle requires infrastructure assistance. Otherwise, it is established, for example, that the motor vehicle does not require infrastructure assistance.

For example, when the target trajectory of the motor vehicle and the target trajectory of the at least one road user intersect or overlap, it is established that the motor vehicle requires infrastructure assistance; otherwise not.

In one embodiment of the method, the steps with regard to the reducing are carried out on the basis of the trajectory signals, such that, depending on the trajectory signals, either “the non-reduced” or “the reduced” is included in the infrastructure assistance data is included in the infrastructure assistance data. This yields, for example, the technical advantage that the reducing can be efficiently carried out.

In one embodiment of the method, a traffic situation in the surroundings of the motor vehicle is determined on the basis of the surroundings signals, wherein, on the basis of the determined traffic situation, it is determined whether the motor vehicle requires infrastructure-based assistance for its journey through the infrastructure. This yields, for example, the technical advantage that it can be efficiently determined whether the motor vehicle requires infrastructure-based assistance for its journey through the infrastructure.

A traffic situation is, for example, an actual state which indicates, for example, a motor vehicle density and/or traffic delays and/or a weather situation in the surroundings of the motor vehicle.

In one embodiment of the method, the steps with regard to the reducing are carried out on the basis of the determined traffic situation, such that, on the basis of the traffic situation, either “the non-reduced” or “the reduced” is included in the infrastructure assistance data is included in the infrastructure assistance data.

In one embodiment of the method, a check is carried out to determine whether the motor vehicle has requested infrastructure-based assistance for its journey through the infrastructure, wherein, on the basis of a result of the check, it is determined whether the motor vehicle requires infrastructure-based assistance for its journey through the infrastructure. This yields, for example, the technical advantage that it can be efficiently determined whether the motor vehicle requires infrastructure-based assistance for its journey through the infrastructure.

For example, it is established that the motor vehicle requires infrastructure-based assistance for its journey when the motor vehicle has requested infrastructure-based assistance for its journey through the infrastructure. It is therefore provided, for example, that only those motor vehicles receive infrastructure assistance that have requested infrastructure assistance.

The check to determine whether the motor vehicle has requested infrastructure-based assistance for its journey through the infrastructure includes, for example, checking to determine whether a message transmitted from the motor vehicle has been received, wherein the message includes a request for a journey by the motor vehicle through the infrastructure. When such a message has been received, it is established, for example, that the motor vehicle has requested infrastructure-based assistance for its journey through the infrastructure.

In one embodiment of the method, it is determined on the basis of the surroundings signals whether the motor vehicle requires a handling recommendation from the infrastructure, which would result in a change to its driving task, and, if so, which, wherein the determination as to whether the motor vehicle requires infrastructure-based assistance for its journey through the infrastructure is carried out on the basis of the determination as to whether the motor vehicle requires a handling recommendation from the infrastructure, which would result in a change to its driving task, such that, when the motor vehicle requires infrastructure-based assistance for its journey through the infrastructure, the infrastructure assistance data include the handling recommendation that changes the driving task. This yields, for example, the technical advantage that the determination as to whether the motor vehicle requires infrastructure-based assistance for its journey through the infrastructure can be efficiently carried out.

According to this embodiment, it is therefore determined at least whether the motor vehicle requires a handling recommendation from the infrastructure, which would result in a change to its driving task. Such a handling recommendation is, for example, a lane-change recommendation, which would result in a change to the driving task of the motor vehicle, which is, in the present case, for example, continuing to travel in the same lane.

When such a handling recommendation is required, it is established, for example, that the motor vehicle requires infrastructure-based assistance. The infrastructure assistance data therefore includes, in particular, the handling recommendation that changes the driving task.

A further technical advantage can be that, when only handling recommendations are transmitted, an algorithm that determines the handling recommendation can be improved in almost any way, without the need to change an interface to the motor vehicle (and thus also the application version in the motor vehicle). The corresponding interface can remain unchanged.

In one embodiment of the method, when the motor vehicle requires infrastructure-based assistance for its journey through the infrastructure, at least one region, in particular a lane, a part of the lane, a driving path, a part of the driving path, in the direction of travel of the motor vehicle the infrastructure assistance data is established, on the basis of which the infrastructure assistance data are determined in a region-based manner. This yields, for example, the technical advantage that the infrastructure assistance data can be efficiently determined.

In one embodiment of the method, data signals are received, which represent motor vehicle data of the motor vehicle and/or communication data of a communication between the motor vehicle and the infrastructure, wherein, on the basis of the data signals, it is determined whether the motor vehicle requires infrastructure-based assistance for its journey through the infrastructure. This yields, for example, the technical advantage that it can be efficiently determined whether infrastructure assistance is required or not.

Motor vehicle data include, for example, diagnostic data of a motor vehicle system, for example, of a propulsion system, a braking system, a steering system, or a lighting system. Motor vehicle data include, for example, motor vehicle-generated surroundings data, which represent a surroundings of the motor vehicle.

Communication data include, for example, an indication whether there is a limitation with regard to the communication between the motor vehicle and the infrastructure. Communication data include, for example, an indication whether a certain radio channel is to be used or must be used for a communication between the infrastructure and the motor vehicle. Communication data include, for example, an indication of an available bandwidth. Communication data include, for example, an indication of a communication network to be used for a communication between the infrastructure and the motor vehicle.

In one embodiment of the method, the method is carried out with the aid of the apparatus according to the second aspect and/or with the aid of the system according to the third aspect.

The system according to the third aspect is designed according to one embodiment, for example, to carry out all steps of the method according to the first aspect.

Method features can be similarly gathered from corresponding apparatus features and system features, and vice versa. Technical functionalities of the vehicle can be similarly gathered from corresponding technical functionalities of the system and of the apparatus, and vice versa. Comments made in conjunction with the method apply similarly for the apparatus and the system, and vice versa.

In one embodiment of the apparatus, the apparatus is programmed to carry out the computer program according to the fourth aspect.

In one embodiment of the system, the system is programmed to carry out the computer program according to the fourth aspect.

In one embodiment of the method, the method is a computer-implemented method.

The wording “at least one” means “one or more”.

In one embodiment of the method, a surroundings sensor is arranged within the infrastructure. The surroundings sensor is, for example, designed to detect a surroundings of the motor vehicle and to output surroundings signals, which are based on the detection and represent the surroundings of the motor vehicle. For example, multiple surroundings sensors are arranged within the infrastructure. Comments made in conjunction with a surroundings sensor apply similarly for multiple surroundings sensors, and vice versa.

A surroundings sensor is, for example, one of the following surroundings sensors: a radar sensor, a LIDAR sensor, an ultrasonic sensor, a magnetic field sensor, an infrared sensor, and an image sensor, in particular an image sensor of a video camera.

The embodiments and examples described here can be used in any combination, even if this is not explicitly described.

An infrastructure-based assistance of the motor vehicle means, in particular, that infrastructure assistance data are made available to the motor vehicle. The motor vehicle can, on the basis of the infrastructure assistance data, for example, derive handling instructions for itself. The motor vehicle can, for example, on the basis of the infrastructure assistance data, make its own decision about what needs to be done. For example, according to the invention, control signals internal to the motor vehicle are generated and output for controlling, in an at least semi-automated manner, a transverse guidance and/or longitudinal guidance of the motor vehicle on the basis of the infrastructure assistance data, in order to control, in an at least semi-automated manner, a transverse guidance and/or longitudinal guidance of the motor vehicle.

Infrastructure assistance data include, for example, one or more of the following elements of data: control command for the at least semi-automated control of a transverse guidance and/or longitudinal guidance of the motor vehicle; remote control command for the at least semi-automated remote control of a transverse guidance and/or longitudinal guidance of the motor vehicle; release command for releasing an at least semi-automated, in particular fully automated, journey of the motor vehicle for a certain time duration within the infrastructure; target trajectory for the motor vehicle; target position within the infrastructure; surroundings data, which represent a surroundings of the motor vehicle; specification as to what the motor vehicle is to do; handling recommendation. A specification can, for example, specify whether the motor vehicle, for example, is permitted to travel or, for example, must stop. The surroundings data include, for example, the list of objects or the reduced list of objects and/or the free-space-detection result or the reduced free-space-detection result.

When the term “free-space-detection result” is used alone, i.e., without being preceded by “reduced”, this should always be understood to mean that this is a complete free-space-detection result.

The same applies for the list of objects. This means that, when the term “list of objects” is used alone, i.e., without being preceded by “reduced”, this should always be understood to mean that this is a complete list of objects.

In one embodiment of the method, the method includes a step of detecting the surroundings of the motor vehicle by utilizing at least one surroundings sensor, wherein surroundings signals, which are based on the detection and represent the detected surroundings, are output in each case by the at least one surroundings sensor.

In one embodiment, it is learned over time when, for example, the step or the steps of reducing is/are to be carried out. For example, it can be determined over time at which (differential) speed between the motor vehicle and another motor vehicle in the surroundings of the motor vehicle it is that infrastructure assistance data should be transmitted.

Method steps are carried out, in particular, at the infrastructure, i.e., by the infrastructure.

In the following, identical reference signs may be used for identical features.

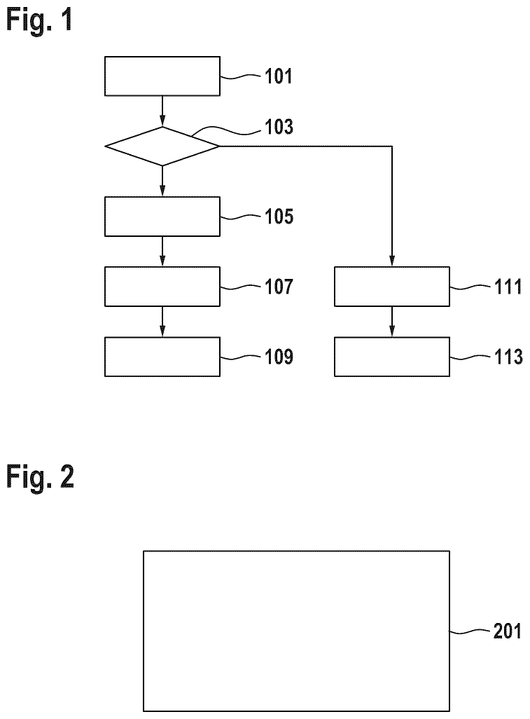

FIG. 1 shows a flow chart of a method for the infrastructure-based assistance of a motor vehicle during a journey through an infrastructure, including the following steps:
receiving 101 surroundings signals, which represent a surroundings of the motor vehicle,
determining 103, in particular on the basis of the surroundings signals, whether the motor vehicle requires infrastructure-based assistance for its journey through the infrastructure,
wherein, when the motor vehicle requires infrastructure-based assistance for its journey through the infrastructure, the method includes the following steps:
determining 105 infrastructure assistance data for the journey of the motor vehicle through the infrastructure, in particular on the basis of the surroundings signals,
generating 107 a periodic message including the determined infrastructure assistance data, and
transmitting 109 the periodic message including the determined infrastructure assistance data to the motor vehicle,
wherein, when the motor vehicle does not require infrastructure-based assistance for its journey through the infrastructure, the method includes the following steps:
generating 111 a periodic message without infrastructure assistance data, and
transmitting 113 the periodic message without infrastructure assistance data to the motor vehicle.

In one embodiment of the method, the method includes a step of detecting the surroundings of the motor vehicle by utilizing at least one surroundings sensor, wherein surroundings signals which are based on the detection and represent the detected surroundings are output in each case by the at least one surroundings sensor.

It is noted that the step 101 is an optional step. In an embodiment which is not shown, the method includes the following steps:
determining 103 whether the motor vehicle requires infrastructure-based assistance for its journey through the infrastructure,
wherein, when the motor vehicle requires infrastructure-based assistance for its journey through the infrastructure, the method includes the following steps:
determining 105 infrastructure assistance data for the journey of the motor vehicle through the infrastructure,
generating 107 a periodic message including the determined infrastructure assistance data, and
transmitting 109 the periodic message including the determined infrastructure assistance data to the motor vehicle,
wherein, when the motor vehicle does not require infrastructure-based assistance for its journey through the infrastructure, the method includes the following steps:
generating 111 a periodic message without infrastructure assistance data, and
transmitting 113 the periodic message without infrastructure assistance data to the motor vehicle.

Method steps are carried out, in particular, at the infrastructure, i.e., by the infrastructure.

FIG. 2 shows an apparatus 201 which is designed to carry out all steps of the method according to the first aspect. The apparatus 201 may be a general purpose computer or any type of controller implemented in motor vehicles.

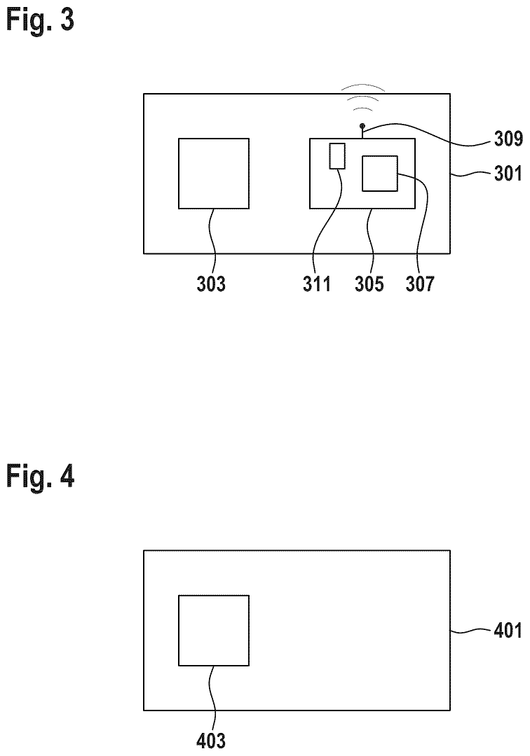

FIG. 3 shows a system 301 for the infrastructure-based assistance of a motor vehicle during a journey through an infrastructure.

The system 301 includes at least one surroundings sensor 303 arranged within the infrastructure, which is designed to detect a surroundings of the motor vehicle and to output surroundings signals, which are based on the detection and represent the surroundings of the motor vehicle.

The system 301 includes an apparatus 305 which is designed to carry out all steps of the method for the infrastructure-based assistance of a motor vehicle during a journey through an infrastructure. The apparatus 305 may be a general purpose computer or any type of controller implemented in motor vehicles. The apparatus 305 includes a data processing unit 307 which is designed to determine whether the motor vehicle requires infrastructure-based assistance for its journey through the infrastructure. The data processing unit 307 is further designed to determine corresponding infrastructure assistance data and to generate a corresponding periodic message. The data processing unit 307 is further designed to generate a periodic message without infrastructure assistance data.

The apparatus 305 includes a wireless communication interface 309 which is designed to transmit the generated periodic message, i.e., in particular the periodic message including the determined infrastructure assistance data and the periodic message without infrastructure assistance data, to the motor vehicle via a wireless communication network.

The apparatus 305 optionally includes a hard-wired communication interface 311 which is, for example, an Ethernet interface. Via the hard-wired communication interface 311, for example, surroundings signals of the surroundings sensor 303 can be received. Alternatively or additionally, for example, the surroundings signals can be received via the wireless communication interface 309. Correspondingly, trajectory signals can be received, for example, via one of the two communication interfaces 309, 311 or by both communication interfaces 309, 311.

FIG. 4 shows a machine-readable storage medium 401 on which a computer program 403 is stored. The machine-readable storage medium 401 is a non-transitory computer-readable medium. The computer program 403 includes commands which, during the execution of the computer program 403 by a computer, prompt the computer to carry out a method for the infrastructure-based assistance of a motor vehicle during a journey through an infrastructure.

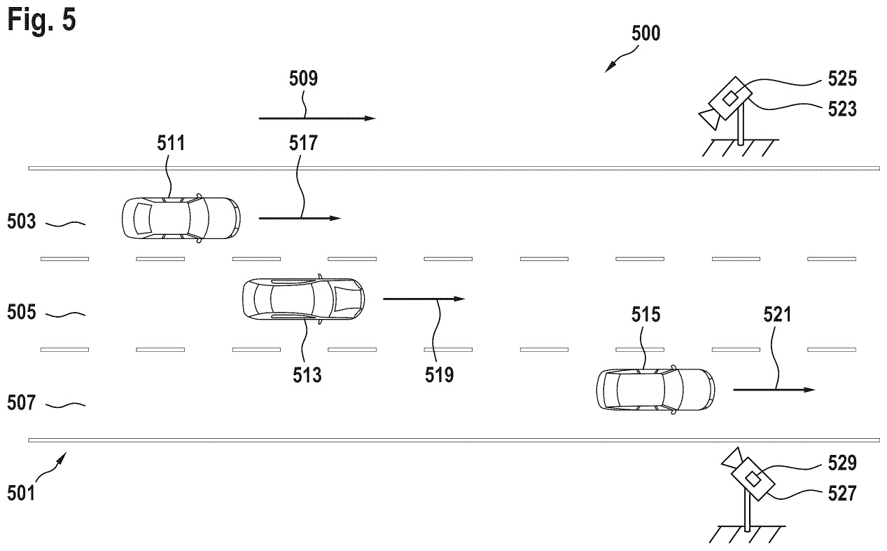

FIG. 5 shows an infrastructure 501 including a three-lane expressway 501. The expressway 501 includes a first lane 503, a second lane 505, and a third lane 507. A specified direction of travel for motor vehicles is indicated by a first arrow having the reference sign 509.

Relative to the direction of travel 509, the first lane 503 is the left lane and the second lane 505 is the middle lane and the third lane 507 is the right lane.

A first motor vehicle 511 is traveling in the left lane 503. A second motor vehicle 513 is traveling in the middle lane 505. A third motor vehicle 515 is traveling in the right lane 507.

The first motor vehicle 511 is not planning to change lanes and instead continues traveling in the first lane 503. This is indicated symbolically using a second arrow having the reference sign 517.

The second motor vehicle 513 is also not planning to change lanes and instead continues traveling in the middle lane 505. This is indicated symbolically using a third arrow having the reference sign 519.

The third motor vehicle 515 is also not planning to change lanes and instead continues traveling in the right lane 507. This is indicated symbolically using a fourth arrow having the reference sign 521.

Relative to the direction of travel 509, a first video camera 523 including a first image sensor 525 is located on the left alongside the left lane 503. Relative to the direction of travel 509, a second video camera 527 including a second image sensor 529 is located on the right alongside the right lane 507.

The two image sensors 525, 529 detect the three motor vehicles 511, 513 and 515 as well as a respective surroundings. On the basis of the detection, the two video cameras 523, 527 output corresponding video images, which are subsequently further processed. On the basis of these video images, it can be, for example, determined whether one of the motor vehicles 511, 513, 515 requires infrastructure-based assistance for a journey on the expressway 501. The video images can be output, for example, to an apparatus according to the second aspect and/or to a system according to the third aspect, in order to carry out the further method steps.

In the exemplary embodiment shown in FIG. 5, all three motor vehicles 511, 513, 515 travel in their respective lanes 503, 505, 507 in a uniform manner and at similar speeds. On the basis of an evaluation of the video images, it can be expected, for example, that none of the motor vehicles 511, 513, 515 requires infrastructure assistance data, i.e., requires infrastructure-based assistance, due to the present situation. It is therefore determined or established that none of the motor vehicles 511, 513, 515 requires infrastructure assistance. In this case, no infrastructure assistance data are determined. A periodic message without infrastructure assistance data is generated and transmitted to the three motor vehicles 511, 513, 515.

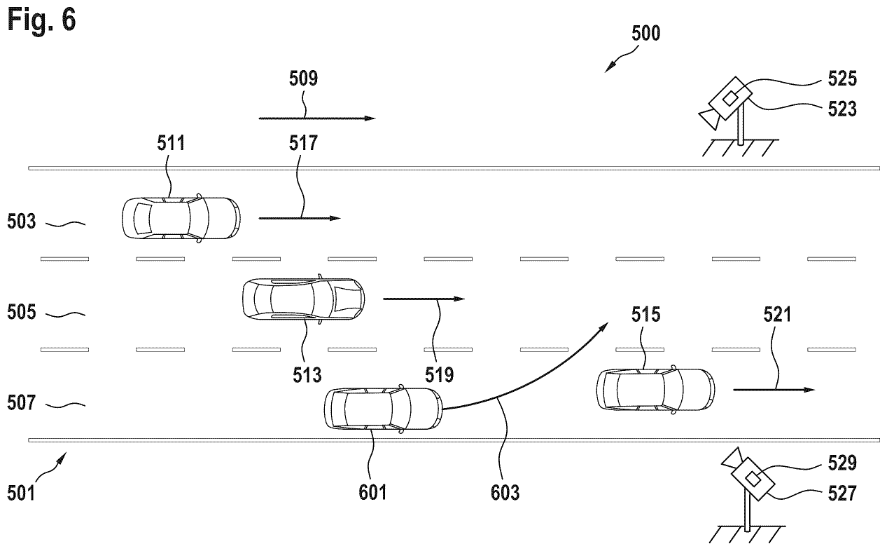

FIG. 6 shows the infrastructure 501 including the three motor vehicles 511, 513, 515. Unlike the situation shown in FIG. 5, a fourth motor vehicle 601 is traveling in the right lane 507. The fourth motor vehicle 601 is planning to change lanes to the middle lane 505, which is indicated symbolically by a curved arrow having the reference sign 603.

This planned lane change can be identified, for example, on the basis of a detection of a correspondingly activated turn signal of the fourth motor vehicle 601 by evaluating the corresponding video images.

For example, the fourth motor vehicle 601 can communicate its planned lane change, i.e., for example to the infrastructure, i.e., for example to an apparatus according to the second aspect and/or to a system according to the third aspect.

Due to this lane change, the second motor vehicle 513 may need to apply the brakes. If necessary, the second motor vehicle 513 could move into the left lane 503 ahead of the first motor vehicle 511. In this case, the first motor vehicle 511 could also apply the brakes. The third motor vehicle 515 is unaffected by the lane change.

In this scenario, it is determined that at least the first motor vehicle 511 and the second motor vehicle 513 require infrastructure-based assistance. For example, it can be determined that the fourth motor vehicle 601 also requires infrastructure-based assistance. In contrast, it is determined that the third motor vehicle 515 does not require infrastructure-based assistance.

Therefore, infrastructure assistance data are determined only for the first motor vehicle 511, the second motor vehicle 513, and optionally for the fourth motor vehicle 601 and transmitted to the motor vehicles by utilizing corresponding periodic messages. In contrast, no infrastructure assistance data are determined for the third motor vehicle 515. Rather, a periodic message without infrastructure assistance data is merely generated and transmitted to the third motor vehicle 515.

In this scenario, therefore, fewer infrastructure assistance data are transmitted to motor vehicles as compared to the case in which infrastructure assistance data are transmitted to all four motor vehicles 511, 513, 515, 601.

In summary, the concept described here makes it possible, in particular, to reduce a number of data to be transmitted to a motor vehicle in a manner that is efficient and safe with regard to a driving function. According to the invention, for example, a periodic message is transmitted to the motor vehicle at regular or periodic time intervals. As a result, it can be advantageously ensured that the recipient of the periodic message, which is the motor vehicle in the present case, is informed that the communication between the infrastructure and the motor vehicle functions. If a periodic message were not transmitted, the recipient, which is the motor vehicle in the present case, would not know whether there are no data that are relevant for the motor vehicle and that the motor vehicle requires for its journey, or whether there is an error in the communication, which resulted in an inability to transmit relevant data.

1. A method for an infrastructure-based assistance of a motor vehicle during a journey through an infrastructure, comprising:
determining whether the motor vehicle requires the infrastructure-based assistance for the journey through the infrastructure;
wherein, when the motor vehicle requires the infrastructure-based assistance for the journey through the infrastructure, the method includes the following steps:
determining an infrastructure assistance data for the journey of the motor vehicle through the infrastructure,
generating a periodic message including the infrastructure assistance data, and
transmitting the periodic message including the infrastructure assistance data to the motor vehicle;
wherein, when the motor vehicle does not require infrastructure-based assistance for the journey through the infrastructure, the method includes the following steps:
generating a periodic message without an infrastructure assistance data, and
transmitting the periodic message without the infrastructure assistance data to the motor vehicle.

2. The method of claim 1, further comprising receiving a plurality of surroundings signals representing a surroundings of the motor vehicle, the infrastructure assistance data is determined based on the surroundings signals.

3. The method of claim 2, wherein the surroundings signals include one or more elements selected from the following groups of signals: a plurality of weather signals, which represent a weather in the surroundings of the motor vehicle; a road state data, which represent a road state of one or more roads in the surroundings of the motor vehicle; a plurality of traffic state signals, which represent a traffic state in the surroundings of the motor vehicle; a plurality of map signals, which represent a digital map of the surroundings of the motor vehicle; a plurality of traffic sign signals, which represent what a traffic sign is displaying and/or will display; a plurality of signals from a plurality of traffic light systems, which represent a current and/or a future signal image of the traffic light systems; a plurality of remaining-time signals, which represent a remaining time of a light signal, in particular of a red light or a green light, of a traffic light system; a surrounding model of the surroundings; an object data describing at least one object in the surroundings; an occupancy status data describing an occupancy status of at least one surface in the surroundings; a surroundings sensor data based on a detection of the surroundings using at least one surroundings sensor; a surroundings sensor data-fusion data based on a plurality of detections of the surroundings using a plurality of surroundings sensors.

4. The method of claim 3, wherein the surroundings sensor data is a surroundings sensor raw data and the surroundings sensor data-fusion data is a surroundings sensor raw data-fusion data.

5. The method of claim 3, further comprising:
determining a list of objects, which indicates a plurality of objects located in the surroundings of the motor vehicle, based on the surroundings signals;
determining a relevance of the objects in the list of objects with regard to a relevance for the journey of the motor vehicle through the infrastructure;
determining, based on the determined relevances, whether the motor vehicle requires the infrastructure-based assistance for the journey through the infrastructure; and
wherein, when the motor vehicle requires the infrastructure-based assistance for the journey through the infrastructure, determining the infrastructure assistance data includes selecting a sub-plurality of objects from the list of objects based on the determined relevances in order to determine a reduced list of objects, which indicates a plurality of selected objects, such that the infrastructure assistance data include the reduced list of objects.

6. The method of claim 2, further comprising carrying out a free space detection based on the surroundings signals to determine a free-space-detection result, which indicates an occupancy status—which is relevant based on the journey of the motor vehicle through the infrastructure—of at least one surface in the surroundings of the motor vehicle, the occupancy status indicates one of the following states: free, occupied, or unknown, wherein, on the basis of the occupancy status, it is determined whether the motor vehicle requires the infrastructure-based assistance for the journey through the infrastructure, and when the motor vehicle requires the infrastructure-based assistance for the journey through the infrastructure, determining the infrastructure assistance data includes selecting a plurality of areas that are either free or occupied and/or have an unknown occupancy status, in order to determine a reduced free-space-detection result, which indicates only free surfaces or occupied surfaces and/or surfaces having an unknown occupancy status, such that the infrastructure assistance data include the reduced free-space-detection result.

7. The method of claim 6, further comprising determining a relevance, which depends on the occupancy status, of the at least one surface with regard to a relevance for the journey of the motor vehicle through the infrastructure, selecting the areas is carried out based on the determined relevance.

8. The method of claim 2, wherein an information content of information represented by the surroundings signals is reduced, such that the infrastructure assistance data include a reduced information content.

9. The method of claim 8, wherein, when the motor vehicle requires the infrastructure-based assistance for the journey through the infrastructure, a meta-information regarding that which is not included in the infrastructure assistance data is determined, such that the infrastructure assistance data include the meta-information.

10. The method of claim 1, wherein the infrastructure assistance data are determined depending on a transmission capacity, which indicates a capacity with regard to a transmission of the infrastructure assistance data to the motor vehicle, and/or on a processing capacity, which indicates a capacity with respect to determining the infrastructure assistance data.

11. The method of claim 10, wherein a plurality of steps with regard to reducing the infrastructure assistance data are carried out based on the transmission capacity and/or based on the processing capacity, such that, depending on the transmission capacity and/or depending on the processing capacity, either a non-reduced data or a reduced data is included in the infrastructure assistance data.

12. The method of claim 1, wherein a plurality of steps with regard to reducing the infrastructure assistance data are carried out based on an established rhythm, such that, based on the established rhythm, either a non-reduced data or a reduced data is included in the infrastructure assistance data.

13. The method of claim 1, wherein a plurality of trajectory signals are determined and/or received, the trajectory signals represent a target trajectory of the motor vehicle and/or of at least one road user in the surroundings of the motor vehicle, wherein, based on the trajectory signals, it is determined whether the motor vehicle requires the infrastructure-based assistance for the journey through the infrastructure, and/or wherein the infrastructure assistance data are determined based on the trajectory signals.

14. The method of claim 13, wherein a plurality of steps with regard to reducing the infrastructure assistance data are carried out based on the trajectory signals, such that, based on the trajectory signals, either a non-reduced data or a reduced data is included in the infrastructure assistance data.

15. The method of claim 1, wherein, based on the surroundings signals, a traffic situation in the surroundings of the motor vehicle is determined, and based on the traffic situation, it is determined whether the motor vehicle requires the infrastructure-based assistance for the journey through the infrastructure.

16. The method of claim 15, wherein a plurality of steps with regard to reducing the infrastructure assistance data are carried out based on the traffic situation, such that, based on the traffic situation, either a non-reduced data or a reduced data is included in the infrastructure assistance data.

17. The method of claim 1, wherein a check is carried out to determine whether the motor vehicle has requested the infrastructure-based assistance for the journey through the infrastructure, wherein, based on a result of the check, it is determined whether the motor vehicle requires the infrastructure-based assistance for the journey through the infrastructure.

18. The method of claim 2, wherein, based on the surroundings signals, it is determined whether the motor vehicle requires a handling recommendation from the infrastructure, which would result in a change to a driving task, and, if so, the determination as to whether the motor vehicle requires the infrastructure-based assistance for the journey through the infrastructure is carried out based on the determination as to whether the motor vehicle requires the handling recommendation from the infrastructure, such that, when the motor vehicle requires the infrastructure-based assistance for the journey through the infrastructure, the infrastructure assistance data include the handling recommendation.

19. The method of claim 1, wherein, when the motor vehicle requires the infrastructure-based assistance for the journey through the infrastructure, at least one region in a direction of travel of the motor vehicle is established, based on which the infrastructure assistance data is determined in a region-based manner.

20. A system for an infrastructure-based assistance of a motor vehicle during a journey through an infrastructure, including:
at least one surroundings sensor arranged within the infrastructure, the at least one surroundings sensor detecting a surroundings of the motor vehicle and outputting a plurality of surroundings signals based on the detection and representing the surroundings of the motor vehicle; and
an apparatus performing the steps of:
determining whether the motor vehicle requires the infrastructure-based assistance for the journey through the infrastructure;
wherein, when the motor vehicle requires the infrastructure-based assistance for the journey through the infrastructure, the method includes the following steps:
determining an infrastructure assistance data for the journey of the motor vehicle through the infrastructure,
generating a periodic message including the infrastructure assistance data, and
transmitting the periodic message including the infrastructure assistance data to the motor vehicle;
wherein, when the motor vehicle does not require infrastructure-based assistance for the journey through the infrastructure, the method includes the following steps:
generating a periodic message without an infrastructure assistance data. and
transmitting the periodic message without the infrastructure assistance data to the motor vehicle.
